(19) United States
(12) Patent Application Publication
(10) Pub. No.: US 2011/0068916 A1
(43) Pub. Date: Mar. 24, 2011

(54) LIFE SAVING SYSTEM WITH RFID TAG HAVING IP COMMUNICATION FUNCTION

(75) Inventors: Hyung Rim CHOI, Busan (KR); Byung Kwon PARK, Busan (KR); Kang Bae LEE, Busan (KR); Gwang Hoon KWARK, Busan (KR); Chang Sup LEE, Busan (KR); Yong Sung PARK, Busan (KR); Hee Yoon KIM, Busan (KR)

(73) Assignee: Dong-A University Research Foundation for Industry-Academy Cooperation, Busan (KR)

(21) Appl. No.: 12/878,588

(22) Filed: Sep. 9, 2010

(30) Foreign Application Priority Data
Sep. 23, 2009 (KR) 10-2009-0090189

(51) Int. Cl. G08B 1/08

(52) U.S. Cl. 340/539.13

(57) ABSTRACT

Disclosed herein is a life saving system with an RFID tag having an IP communication function. The life saving system using RFID tags and a GPS comprises a plurality of RFID tags respectively attached to life jackets of survivors, respectively transmitting distress signals, and transmitting distress signals of other RFID tags when receiving the distress signals from the other RFID tags; smart points arranged in a distress area at predetermined intervals, including position information in the distress signals and transmitting the distress signals with the position information through satellite communication; and a control tower receiving the distress signals including the position information and transmitting a saving command.

### BACKGROUND OF THE INVENTION

1. Field of the Invention

The present invention relates to a life saving system using radio frequency identification (RFID) tags and a global positioning system (GPS) and an operating method thereof. More specifically, the invention relates to a life saving system using RFID tags and a GPS and an operating method thereof used for shipwreck.

2. Background of the Related Art

A GPS is a system providing position information. The GPS can accurately calculate the current position using time and three different distances from at least three satellites according to trigonometry by using a GPS receiver. A method of obtaining distance and time information from three satellites and correcting errors using a single satellite is currently widely used. The GPS can obtain even correct time with velocity information in addition to positions of latitude, longitude and altitude, which is distinguished from compass. A military GPS and a civil GPS have different position accuracies. The civil GPS has horizontal and vertical errors in the range of 10 to 15 m and velocity measurement accuracy of 3 cm per second. Three atomic clocks are mounted in an artificial satellite so as to provide time information having an error of only one second per 36000 years. The GPS is used in wide areas such as simple position information providing services, automatic navigation and traffic control of airplanes, ships and vehicles, prevention of collision of oil tanker, precise measurement of large-scale public works, cartography, etc. A variety of GPS receivers such as portable GPS receivers and GPS receivers mounted on satellites have been developed.

Mario Cardullo patented for the first RFID having a memory and transmitting/receiving radio waves in 1973. The Cardullo patent had an idea that uses radio waves, sound waves and light for communication. In the same year, Steven Deb demonstrated a RFID technique providing a limited output in Los Alamos National Lab. This RFID is currently used for most RFID tags.

The RFID has been constantly developed for last ten years with the development of semiconductor technology and the advent of the Internet and applied to various areas such as circulation, distribution, medical treatment, education, etc. It is expected that RFID tags are attached to almost all goods in several years from now so as to greatly contribute to construction of ubiquitous environments.

The RFID is an automatic data collection (ADC) technique that performs data communication between a moving object and a recognizer. An RFID tag can perform communication even when the RFID tag is moving because RFID is fast and reliable and the RFID tag is not exposed but covered. Unlike bar codes, the RFID tag does not require direct aiming to be recognized. Furthermore, data of the RFID tag is easily changed and added and a large amount of tags can be read at the same time. Moreover, the RFID tag has a high reading rate even in poor reading environments such as cold, hot and humid places and places having dust and heat. In addition, the RFID tag cannot be forged, is semi-permanent and can be recycled.

The RFID uses radio waves in LF, HF, UHF waves and microwave bands and is applied to various areas such as animal tracing, transportation cards, products management, electronic cash according to radio wave characteristics of the frequency bands. The RFID is divided into fixed RFID, portable RFID and mobile RFID according to terminal forms. As a recent mobile RFID service using a cellular phone with an RFID reader function, such as taxi secure returning home service, is introduced, the RFID is penetrating into out lives. Furthermore, many researches, verification experiments, demonstration services and real businesses including active RFID techniques requiring a long recognition distance such as harbor distribution management are performed. Moreover, ILT technique for attaching a tag each article instead of attaching a tag to each pallet or each case is being introduced. While only proximity RFID used for bus cards, entrance security cards and attendance cards, which have no close relationship to commerce, is currently used in the country, the RFID will be rapidly spread to circulation and distribution areas. Since the RFID has recognition, tracking and classification functions, methods for using the RFID and GPS for life saving are required.

### SUMMARY OF THE INVENTION

Accordingly, the present invention has been made in view of the above-mentioned problems occurring in the prior art, and it is a primary object of the present invention to provide a life saving system using smart points and RFID tags and an operating method thereof.

To accomplish the above object of the present invention, according to the present invention, there is provided a life saving system using RFID tags and a GPS, which comprises a plurality of RFID tags respectively attached to life jackets of survivors, respectively transmitting distress signals, and transmitting distress signals of other RFID tags when receiving the distress signals from the other RFID tags; smart points arranged in a distress area at predetermined intervals, including position information in the distress signals and transmitting the distress signals with the position information through satellite communication; and a control tower receiving the distress signals including the position information and transmitting a saving command.

Each smart point may comprise a GPS module receiving the position information from a GPS satellite and periodically updating the position information; a tag reader receiving the distress signals; and a satellite communication module transmitting the distress signals with the position information to the control tower through satellite communication.

The smart point may be included in a waterproof material and a buoyant material.

Each RFID tag may comprise a memory storing the distress signal of the RFID tag, which includes an identifier for identifying the RFID tag; a transceiver transmitting the distress signal and receiving a distress signal from another RFID tag; and a battery supplying power to the RFIG tag.

To accomplish the above object of the present invention, according to the present invention, there is also provided a method of operating a life saving system using RFID tags and a GPS, which comprises a first step in which one of a plurality of RFID tags transmits a first distress signal; a second step in which another RFID tag that receives the first distress signal transmits the first distress signal and a second distress signal thereof; a third step in which one of smart points arranged in a distress area at predetermined intervals includes position information in the first and second distress signals and transmits the first and second distress signals including the position information; and a fourth step in which a control tower receives the first and second distress signals including the position information and transmits a saving command.

The position information may be received from a GPS satellite and periodically updated.

The third step may transmit the first and second distress signals to the control tower through satellite communication.

The smart points may be included in a waterproof material and buoyant material and float.

The first and second distress signals may respectively include identifiers for identifying the RFID tags.

The method may further comprise a step of distributing the smart points to the distress area by at least one of a saving air vehicle, a saving ship, a wrecked ship and a wrecked air vehicle before the first step.

According to the present invention, the smart point is distributed to a wrecked ship or a wrecked airplane, and thus the smart point is moved with survivors when the survivors are moved by sea current so as to be located together with the survivors. Furthermore, since the position of the smart point is transmitted through a GPS, a search range can be narrowed. Particularly, even if any survivor does not exist in the range of the smart point, a saving range can be reduced because the position of the smart point is known. In addition, a distress signal is transmitted to the smart point using multiple RFID tags through multi-hop communication, and thus even a survivor who is located out of the receiving range of the smart point can be searched.

The RFID tag includes sensors such as a thermometer and a pulsimeter used to confirm whether a survivor survives, and thus it is possible to discriminate survivors from the dead to determine a saving order.

Moreover, since communication with a GPS satellite is performed through the smart point instead of the RFID tag, life saving system construction cost can be decreased.

The RFID tag that has an IP communication function and can be used for relatively long time due to high efficiency battery consumption is attached to a life jacket to transmit a distress signal and the position information of the RFID tag is transmitted using the GPS module of the smart point, which can use a battery having relatively large capacity, and thus the system can be continuously operated.

In addition, since the RFID tag attached to the life jacket has a VoIP (Voice over IP) function, various management functions with respect to the life jacket can be preformed on-line through IP communication. Accordingly, the system can be effectively operated. Furthermore, a survivor can communicate with a control tower and a life saver through voices until saved, and thus mental security can be provided to the survivor.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 illustrates a life saving system according to an embodiment of the present invention;

FIG. 2 is a block diagram for explaining an RFID tag and a tag reader according to an embodiment of the present invention;

FIG. 3 is a block diagram for explaining a smart point according to an embodiment of the present invention;

FIG. 4 is a flowchart showing a distress signal transmitting method of an RFID tag according to an embodiment of the present invention;

FIG. 5 is a flowchart showing an operation of the smart point according to an embodiment of the present invention; and

FIG. 6 illustrates a method of operating a life saving system according to an embodiment of the present invention.

### DETAILED DESCRIPTION OF THE PREFERRED EMBODIMENT

Reference will now be made in detail to the preferred embodiments of the present invention with reference to the accompanying drawings. The detailed description, which will be given below with reference to the accompanying drawings, is intended to explain exemplary embodiments of the present invention, rather than to show the only embodiments that can be implemented according to the invention. The following detailed description includes specific details in order to provide a thorough understanding of the present invention. However, it will be apparent to those skilled in the art that the present invention may be practiced without such specific details.

Distress may occur in the sea or on the land such as mountains. Although a life saving method according to an embodiment of the present invention will be explained on the case of survivors in the sea, the present invention is not limited thereto.

It is assumption that the survivors wear life jackets with RFID tags attached thereto. In embodiments of the present invention, the RFID tags are Internet Protocol (IP) tags and wireless near field communication can be performed between the RFID tags. Accordingly, multiple RFID tags can execute multi-hop communication. Furthermore, the IP tags can periodically broadcast distress signals.

In the embodiments of the present invention, a distress signal represents occurrence of distress and calls for help. The distress signal includes an identifier for identifying the RFID tag that generates the distress signal. The distress signal may be transmitted to a smart point according to an embodiment of the present invention through multi-hop communication between RFID tags.

When there are multiple survivors in the sea, as described above, an air vehicle for saving the survivors, for example, a helicopter or an airplane, distributes smart points for confirming the positions of the survivors in a specific range above the area where the survivors are located. That is, a plurality of smart points are arranged in a specific range estimated to be an area where the survivors are located. One smart point includes a GPS module and receives position information from a GPS satellite through the GPS module. Furthermore, the smart point includes an RIFD tag reader (referred to as a tag reader hereinafter) for acquiring a distress signal from an RIFD tag.

Though a distress signal receiving range of the smart point is limited, even a distress signal from a survivor located out of the distress signal receiving range of the smart point can be received if the distress signal is transmitted through an IP tag capable of performing multi-hop communication.

A life saving system according to an embodiment of the present invention will now be explained with reference to the attached drawings.

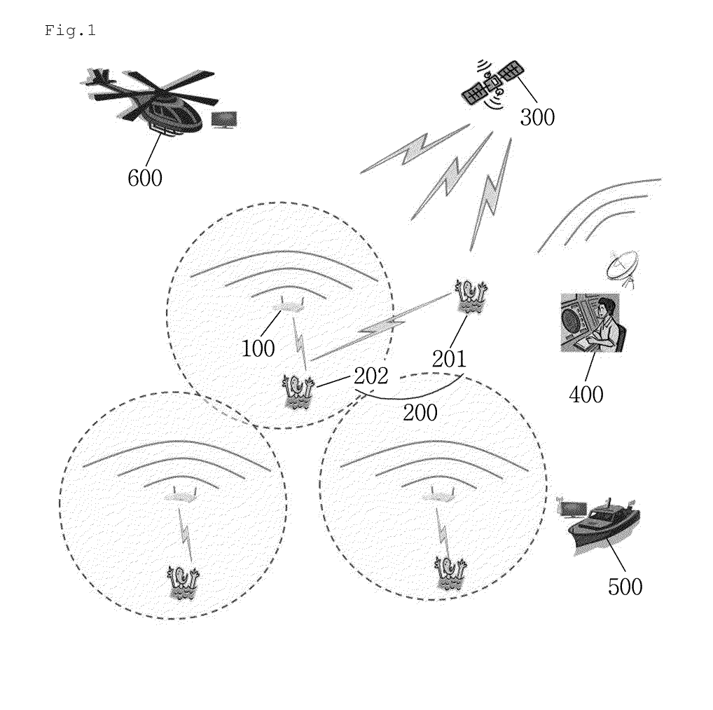

FIG. 1 illustrates a life saving system according to an embodiment of the present invention.

Referring to FIG. 1, the life saving system includes smart points 100, RFID tags 200, an artificial satellite 300, and a ground control tower 400. In addition, the life saving system further includes a ship 500 and an air vehicle 600 for saving survivors.

The smart points 100 receive distress signals from the RFID tags 200 and transmit the received distress signals with position information to the artificial satellite 300.

Each smart point 100 includes a GPS module, a tag reader, and a satellite communication module. The GPS module receives position information of the smart point 100 from a GPS satellite at a predetermined interval and stores the received position information. The tag reader receives distress signals from RFID tags. The distress signals may be received from RFID tags located in the receiving range of the tag reader or RFID tags located out of the receiving range of the tag reader. The satellite communication module transmits the position information and the received distress signals to the ground control tower 400 through satellite communication.

The smart points 100 are arranged in an area estimated to be a region where survivors are drifting. For example, the air vehicle 600 for saving survivors may drop the smart points 100 to the area at a specific interval. Although the smart points 100 are distributed by the air vehicle 600 in the current embodiment of the present invention, the present invention is not limited thereto. That is, the smart points 100 may be distributed by a ship, a wrecked ship or a wrecked air vehicle.

Furthermore, the smart point 100 may further include a floating device such that the tag reader can receive distress signals. That is, the floating device is attached to the smart point 100 to float the smart point 100 on the water. The floating device may be formed of the same material as that of a life jacket. However, the present invention is not limited thereto.

The RFID tags 200 periodically transmit distress signals. The RFID tags 200 may transmit the distress signals through a broadcast method.

One RFID tag 200 may receive a distress signal from another RFID tag and broadcast the received distress signal. That is, wireless near field communication can be performed between RFID tags 200. A distress signal can be transmitted to the smart point 100 through relay between the RFID tags 200. Accordingly, even distress signals from RFID tags 200 located out of the receiving range of the smart point 100 can be transmitted to the smart point 100.

For example, it is assumed that three survivors who wear life jackets with IP tags attached thereto are drifting, first, second and third IP tags are respectively attached to the life jackets, the first IP tag is closest to one smart point 100, the third IP tag is located most distant from the smart point 100, and the second IP tag is located between the first and third IP tags.

When the second and third IP tags are not located in the receiving range of the smart point 100 while the first IP tag is located in the receiving range of the smart point 100, a distress signal of the third IP tag may be transmitted to the smart point 100 through the first IP tag.

Furthermore, when the receiving range of the first IP tag cannot receive the distress signal of the third IP tag, the distress signal of the third IP tag may be transmitted to the first IP tag via the second IP tag, and thus the first IP tag transmits the distress signal of the third IP tag, received from the second IP tag, to the smart point 100.

The artificial satellite 300 receives distress signals from the smart points 100 and transmits the distress signals to the ground control tower 400.

The ground control tower 400 acquires position information of survivors from the distress signals received from the artificial satellite 300 and notifies the saving ship 500 and air vehicle 600 of the position information. The saving ship 400 and air vehicle 600 may receive the position information, search and save the survivors according to the received position information.

The RFID tag 200 transmitting or relaying a distress signal and the tag reader 110 receiving the distress signal transmitted from the RFID tag 200 will now be explained.

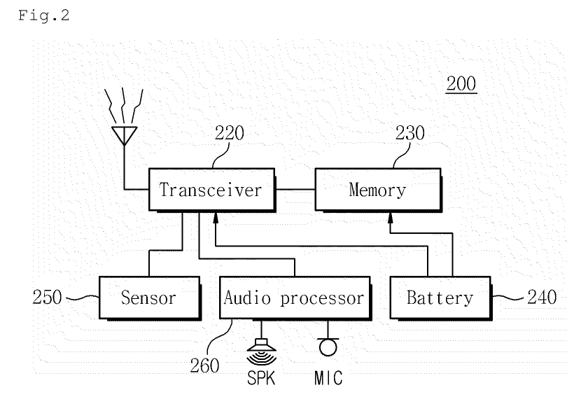

FIG. 2 is a block diagram for explaining the RFID tag and the tag reader according to an embodiment of the present invention.

The RFID tag 200 transmits, receives and relays a distress signal.

That is, the RFID tag 200 can generate and transmit a distress signal, receive a distress signal of another RFID tag 200 apart from the RFID tag by one hop and transmit the received distress signal. To achieve this, the RFID tag 200 includes an antenna, a transceiver 220, a memory 230, and a battery 240.

The antenna transmits and receives signals of radio frequency set by RFID tag regulation.

The transceiver 220 transmits and receives data through a radio frequency signal. The transceiver 220 can discriminates transmission from receiving according to a frequency shift keying (FSK) method. Here, the data is a distress signal including an identifier for identifying the RFID tag 200 having the transceiver 220.

The memory 230 stores the distress signal including the identifier. The memory 230 may temporarily store a distress signal of another RFID tag if the RFID tag 200 receives the distress signal from the other RFID tag.

The battery 240 supplies power to the RFID tag 200.

The tag reader is a receiver receiving distress signals transmitted in radio frequency. Accordingly, the tag reader includes an antenna for receiving the radio frequency. The antenna of the tag reader signals of radio frequency set by the RFID tag regulation.

The RFID tag 200 may further includes a sensor 250 for confirming whether a survivor survives and an audio processor 260 for voice communication. In addition, the RFID tag 200 may further include a microprocessor for controlling the functions of the components of the RFID tag 200.

The sensor 250 includes a thermometer or a pulsimeter meter used to confirm whether a survivor survives. Sensing information obtained by the sensor 250 may be used as information for discriminating survivors from the dead and determining a saving order.

The audio processor 260 outputs the voice of the control tower 400 or a life saver through a speaker SPK, digitalizes the voice of a survivor, input through a microphone MIC, and outputs the digitalized voice. That is, voice communication can be performed via the smart point 100 if the transceiver 220 supports VoIP (Voice over IP) function. The RFID tag 200 supporting the VoIP function can give mental security to survivors because the RFID tag 200 supports continuous voice communication with the ground control tower 400 or the survivors.

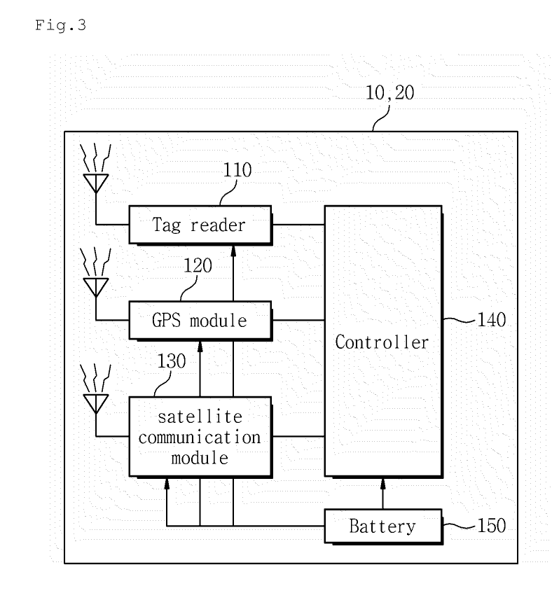

The smart point 100 according to an embodiment of the present invention will now be explained. FIG. 3 is a block diagram for explaining the smart point 100.

Referring to FIG. 3, the smart point 100 is included in a waterproof material 100 and a buoy 20. The smart point 100 includes the tag reader 110, a GPS module 120, a satellite communication module 130, a controller 140, a battery 150.

The waterproof material 10 protects the tag reader 110, the GPS module 120, the satellite communication module 130, the controller 140, and the battery 50 from seawater.

The buoy 20 floats the smart point 100 on the sea to receive distress signals and provides buoyancy capable of floating the tag reader 110, the GPS module 120, the satellite communication module 130, the controller 140, and the battery 150. The buoy 20 may be made of the same material as that of e life jacket.

The waterproof material 10 and the buoy 20 may be integrated with each other.

The tag reader 110 is a receiver receiving radio frequency signals, receives a distress signal in the band of radio frequency from the RFID tag 200 and provides the received distress signal to the controller 140.

The GPS module 120 includes an antenna for receiving a high-frequency GPS signal, down-converts the high-frequency GPS signal received through the antenna, converts the down-converted analog signal into a digital signal, and extracts position information from the digital signal.

The GPS module 120 periodically receives and updates the position information. The smart point 100 continuously moves while floating on the sea. Accordingly, the GPS module 120 periodically receives the position information of the smart point 100 and continuously updates the position information that is varied as the smart point 100 moves.

The GPS module 120 provides the updated position information to the controller 140.

The satellite communication module 130 transmits a distress signal received by the tag reader 110 and the position information updated by the GPS module 120 to a satellite through satellite communication under the control of the controller 140. As described above, the distress signal of the RFID tag 200 is continuously received from the RFID tag 200, and the satellite communication module 130 transmits the latest position information received at the time when the distress signal is received to the satellite under the control of the controller 140. Accordingly, the position of a survivor can be continuously traced.

The controller 140 maps the distress signal received from the tag reader 110 to the position information received from the GPS module 120 and provides the distress signal with the position information to the satellite communication module 130. Here, if multiple distress signals identified by different identifiers are received, the controller 140 can provide the multiple distress signals and the latest position information to the satellite communication module 130.

The battery 150 provides power to the tag reader 110, the GPS module 120, the satellite communication module 130 and the controller 140 of the smart point 100 and has capacity greater than that of the battery 240 of the RFID tag 200.

Operations of the RFID tag 200 and the smart point 100 and a method of operating the life saving system will now be explained.

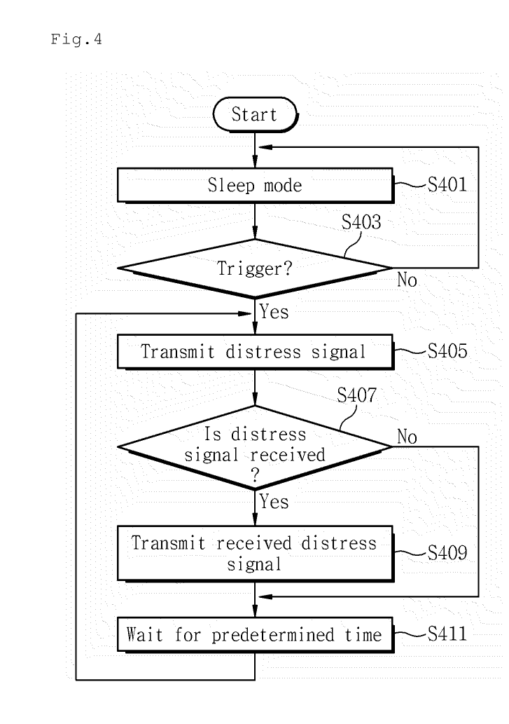

A distress signal transmitting method of the RFID tag according to an embodiment of the present invention is described first. FIG. 4 is a flowchart showing the distress signal transmitting method of the RFID tag.

The RFID tag cannot use a large-capacity battery because the size of the RFID tag is restricted and the battery of the RFID tag cannot be used for a long time. Accordingly, the RFID tag is in a sleep mode in which the battery is not used in step S401. The RFID tag 200 maintains the sleep mode until triggered in step S403.

When the RIFD tag 200 is triggered, the RFID tag 200 transmits a distress signal in step S405. Here, the RFID tag transmits the distress signal using a broadcast method, and thus any radio frequency receiver using the same frequency as the transmission frequency of the RIFD tag can receive the distress signal. Particularly, when the transmission range of a certain RIFD tag cannot reach the smart point 100, another RFID tag having a transmission range that reaches the smart point may receive a distress signal of the certain RFID tag and transmit the received distress signal to the smart point 100.

Accordingly, when the RFID tag receives a distress signal from another RFID tag in step S407, the RFID tag transmits the received distress signal in step S409. When the RFID tag does not receive a distress signal in step S407, the RFID tag executes step S411.

The RIFD tag waits for a predetermined time in step S411 and repeats steps S405, S407, S409 and S411. This operation is repeated until the battery of the RFID tag is discharged.

As described above, the RIFD tag periodically transmits a distress signal. Furthermore, a distress signal can be relayed to the smart point 100 through multiple RFID tags.

Accordingly, even an RFID tag that does not belongs to the receiving range of the smart point 100 (the transmission range of an RFID tag) can transmit a distress signal to the smart point 100 according to multi-hop transmission through relay of another RFID tag.

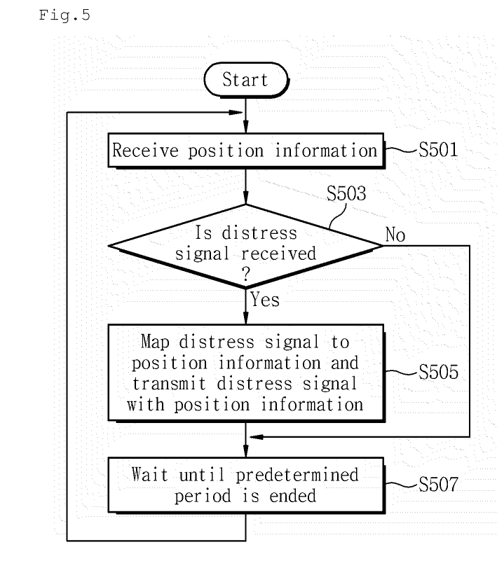

The operation of the smart point according to an embodiment of the present invention will now be explained. FIG. 5 is a flowchart showing the operation of the smart point.

Referring to FIG. 5, the smart point 100 receives position information in step S501. The smart point 100 periodically receives and updates the position information by repeating an operation of waiting until a predetermined period is ended and executing step S501.

When the smart point 100 receives a distress signal while repeating the aforementioned operation in step S503, the smart point 100 maps the distress signal and the position information to each other and transmits the distress signal with the position information to a satellite in step S505. Here, the position information is the latest position information according to repetition of steps S501 and S507, and thus the smart point can continuously transmit the latest position information received at the time when a distress signal is received.

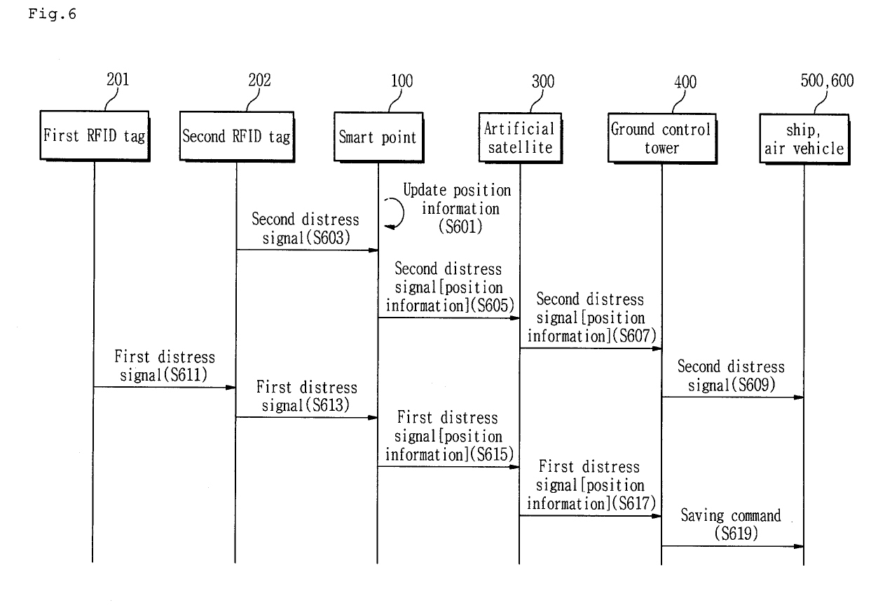

The method of operating the life saving system according to an embodiment of the present invention will now be explained. FIG. 6 illustrates the method of operating the life saving system.

In FIG. 6, it is assumed that first and second RFID tags 201 and 202 are attached to life jackets of different survivors, the first RFID tag 201 is located out of the receiving range of the smart point 100 and the second RFID tag 202 is located in the receiving range of the smart point 100. That is, it is assumed that the survivor who wears the life jacket with the first RFID tag attached thereto is drifting in an area out of the receiving range of the smart point 100 while the survivor who wears the life jacket with the second RFID tag attached thereto is drifting in an area belonging to the receiving range of the smart point 100. The receiving range of the smart point 100 is the receiving range of the tag reader of the smart point 100 and corresponds to the transmission range of the RFID tag 201 and 202.

When the smart point 100 is distributed to a distress area by the air vehicle 600 or the ship 500, the smart point 100 updates position information thereof at a predetermined interval in step S601. That is, the smart point 100 periodically updates the position information thereof through the GPS module. The smart point 100 may be directly distributed by a wrecked air vehicle or a wrecked ship.

The first and second RFID tags 201 and 202 continuously transmit distress signals after triggered. Assume that the distress signal transmitted from the first RFID tag 201 is a first distress signal and the distress signal transmitted from the second RFID tag 202 is a second distress signal.

The second RFID tag 202 transmits the second distress signal including an identifier for identifying the second RFID tag 202 in step S603.

Since the second RFID tag 202 is located in the receiving range of the smart point 100, the smart point 100 can directly receive the second distress signal.

The smart point 100 transmits the received second distress signal with the latest position information to the satellite 300 in step S605.

The satellite 300 receives the second distress signal with the position information and transmits the received second distress signal with the position information to the ground control tower 400 in step S607.

The ground control tower 400 receives the second distress signal with the position information, confirms the position of a survivor, and transmits a saving command including the position of the survivor to the ship 500 and the air vehicle 600 for saving survivors in step S609. The ship 500 and the air vehicle 600 search and save the survivor according to the saving command.

The first RFID tag 201 transmits the first distress signal through a broadcast method in step S611. If the second RFID tag 202 is located in the transmission range of the first RFID tag 201, the second RFID tag 202 can receive the first distress signal of the first RFID tag 201.

If the second RFID tag 202 receives the first distress signal of the first RFID tag 201, the second RFID tag 202 transmits the first distress signal to the smart point 100 in step S613.

The smart point 100 that receives the first distress signal transmits the position information of the smart point 100 and the first distress signal to the satellite 300 in step S615. The satellite 300 receives the first distress signal with the position information and transmits the received first distress signal with the position information to the ground control tower 400 in step S617.

The ground control tower 400 receives the first distress signal with the position information, confirms the position of a survivor, and transmits a saving command including the position of the survivor to the ship 500 and the air vehicle 600 in step S619. The ship 500 and the air vehicle 600 search and save the survivor according to the saving command.

Though there are two RFID tags 201 and 202 in the current embodiment of the invention, shown in FIG. 6, a distress signal can be transmitted to the smart point 100 through relay of more than two RFID tags.

As described above, according to the present invention, the RFID tag that can be used for relatively long time using a small-capacity battery is attached to a life jacket to transmit a distress signal from the RFID tag and position information is transmitted using the GPS module 120 of the smart point 100 that can use a battery having relatively large capacity, and thus the system can be continuously operated with efficiency.

Furthermore, a distress signal may be transmitted to the smart point 100 using multiple RFID tags 200 through multi-hop communication to search a survivor located out of the receiving range of the smart point 100.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A life saving system using RFID tags and a GPS comprising:
a plurality of RFID tags respectively attached to life jackets of survivors, respectively transmitting distress signals, and transmitting distress signals of other RFID tags when receiving the distress signals from the other RFID tags;
smart points arranged in a distress area at predetermined intervals, including position information in the distress signals and transmitting the distress signals with the position information through satellite communication; and
a control tower receiving the distress signals including the position information and transmitting a saving command.

2. The life saving system of claim 1, wherein each smart point comprises:
a GPS module receiving the position information from a GPS satellite and periodically updating the position information;
a tag reader receiving the distress signals; and
a satellite communication module transmitting the distress signals with the position information to the control tower through satellite communication.

3. The life saving system of claim 1, wherein the smart point is included in a waterproof material and a buoyant material.

4. The life saving system of claim 1, wherein each RFID tag comprises:
a memory storing the distress signal of the RFID tag, which includes an identifier for identifying the RFID tag;
a transceiver transmitting the distress signal and receiving a distress signal from another RFID tag; and
a battery supplying power to the RFIG tag.

5. The life saving system of claim 4, wherein the RFID tag further comprises a sensor for sensing the body temperature or pulse of a survivor to confirm whether the survivor survives and outputting sensing information, wherein the transceiver includes the sensing information in the distress signal and transmitting the distress signal including the sensing information.

6. The life saving system of claim 4, wherein the transceiver supports VoIP (Voice over IP), and the RFID tag further comprises an audio processor that outputs the voice of the control tower or a survivor through a speaker, digitalizes the voice of the survivor, input through a microphone, and outputs the digitalized voice.

7. A method of operating a life saving system using RFID tags and a GPS, comprising:
a first step in which one of a plurality of RFID tags transmits a first distress signal;
a second step in which another RFID tag that receives the first distress signal transmits the first distress signal and a second distress signal thereof;
a third step in which one of smart points arranged in a distress area at predetermined intervals includes position information in the first and second distress signals and transmits the first and second distress signals including the position information; and
a fourth step in which a control tower receives the first and second distress signals including the position information and transmits a saving command.

8. The method of claim 7, wherein the position information is received from a GPS satellite and periodically updated.

9. The method of claim 7, wherein the third step transmits the first and second distress signals to the control tower through satellite communication.

10. The method of claim 7, wherein the smart points are included in a waterproof material and buoyant material and float.

11. The method of claim 7, wherein the first and second distress signals respectively include identifiers for identifying the RFID tags.

12. The method of claim 7, further comprising a step of distributing the smart points to the distress area by at least one of a saving air vehicle, a saving ship, a wrecked ship and a wrecked air vehicle before the first step.
